(19) United States
(12) Patent Application Publication
(10) Pub. No.: US 2024/0088486 A1
(43) Pub. Date: Mar. 14, 2024

(54) ELECTROLYTE ADDITIVES FOR ENERGY CONVERSION DEVICES AND ENERGY CONVERSION DEVICES THEREOF

(71) Applicant: Log9 Materials Scientific Pvt. Ltd., Bangalore (IN)

(72) Inventors: Gayathri Sridhar, Madurai (Tamil Nadu) (IN); Anshul Kumar Sharma, Bangalore (Karnataka) (IN); Suman Dutta, Kharagpur (West Bengal) (IN)

(73) Assignee: Log9 Materials Scientific Pvt. Ltd., Bangalore (IN)

(21) Appl. No.: 18/368,198

(22) Filed: Sep. 14, 2023

(30) Foreign Application Priority Data
Sep. 14, 2022 (IN) 202241052441

(51) Int. Cl. H01M 12/06; H01M 4/90; H01M 4/96

(52) U.S. Cl. CPC H01M 12/06; H01M 4/9041; H01M 4/96; H01M 8/083; H01M 2300/0014

(57) ABSTRACT

An energy conversion device includes a cathode, an anode including an aluminium-magnesium alloy, and an alkaline electrolyte disposed between the cathode and the anode. The alkaline electrolyte includes an electrolyte additive that includes zinc oxide, L-cysteine, or a combination thereof.

### CROSS-REFERENCE TO RELATED APPLICATIONS

This application claims priority under 35 U.S.C. 119(a) from Indian provisional patent application No. 202241052441 filed on Sep. 14, 2022, which is pending and which hereby incorporated by reference in its entirety for all purposes.

### TECHNICAL FIELD

The present disclosure generally relates to an energy conversion device. More particularly, the invention relates to electrolyte additives for an energy conversion device such as a metal-air battery.

### BACKGROUND OF THE INVENTION

Metal-air batteries are potential alternatives to lithium-ion batteries. Metal-air batteries have the advantages of high energy density and lower fire risk as compared to lithium-ion batteries. The metal-air battery works on the principle of electrochemical charge/discharge reactions that occur between the air-cathode and a metal anode. When the battery is discharged, oxygen from the atmosphere diffuses through the air cathode, where a catalyst facilitates its reduction while the metal anode undergoes oxidation. The high energy density of the metal-air batteries makes them desirable for the electrification of vehicles, especially those in the long-haul category, and for storing energy from renewable sources, which is otherwise not possible with the current lithium-ion batteries.

Aluminium is a good candidate for use in metal-air batteries as a metal anode, due to its lightweight, high energy density (˜8,100 watt-hours per kilogram), easy availability and low environmental impact. However, one of the major issues with aluminium is that it tends to get passivated with a layer of aluminium oxide on its surface, when exposed to air, or aqueous media, thus hampering its operation as the metal anode.

To mitigate this issue, a highly alkaline solution is generally used as an electrolyte with the metal anode. The alkaline solution, however, favours the production of hydrogen (referred to as hydrogen evolution reaction (HER) at the metal anode, which reduces the battery performance. To reduce HER at the metal anode, an additive is generally used with the electrolyte. The additive typically forms a protective layer upon the surface of the metal anode, which inhibits HER without compromising the performance of the metal anode.

Another approach is to use an aluminium alloy for the metal anode as the aluminium alloy exhibits a higher overpotential for HER than that of aluminium. However, it has been a challenge to reduce HER to improve the performance of the metal anode and hence the battery performance.

Thus, there is a need in the art for the development of more efficient metal-air batteries.

### SUMMARY OF THE INVENTION

An embodiment of the present disclosure is an energy conversion device. The energy conversion device includes a cathode, an anode, and an alkaline electrolyte disposed between the cathode and the anode. The anode includes an aluminium-magnesium alloy. The alkaline electrolyte includes an electrolyte additive. The electrolyte additive includes zinc oxide, L-cysteine, or a combination thereof.

Another embodiment of the present disclosure is a metal-air battery. The aluminium-air battery includes a cathode, an anode having an aluminium-magnesium alloy, and an alkaline electrolyte disposed between the cathode and the anode. The alkaline electrolyte includes potassium hydroxide and an electrolyte additive that comprises zinc oxide and L-cysteine.

These and other objects of the invention herein will be better appreciated and understood when considered in conjunction with the following description and the accompanying drawings. It should be understood, however, that the following descriptions, while indicating embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments of the invention are illustrated in the accompanying drawings, throughout which the reference letters indicate the corresponding part in the various figures. The embodiments herein will be better understood from the following description with reference to the drawings, in which:

FIG. 1 is a schematic diagram of an energy conversion device, in accordance with an embodiment of the present disclosure.

FIG. 2 is a plot of voltage (V) versus time (T) during multiple discharge cycles of a metal-air battery.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

In the specification and the claims which follow, reference will be made to a number of terms which shall be defined to have the following meanings:

The singular forms “a”, “an” and “the” include plural referents unless the context clearly dictates otherwise. “Optional” or “optionally” means that the subsequently described event or circumstance may or may not occur, and that the description includes instances where the event occurs and instances where it does not. “Substantially” means a range of values that is known in the art to refer to a range of values that are close to, but not necessarily equal to a certain value.

Other than in the examples or where otherwise indicated, all numbers or expressions referring to quantities of ingredients, reaction conditions, and the like, used in the specification and claims are to be understood as modified in all instances by the term “about.” In some aspects of the current disclosure, the terms “about” or “approximately” are defined as being close to as understood by one of ordinary skill in the art, and in one non-limiting embodiment the terms are defined to be within 10%, alternatively within 5%, alternatively within 1%, or alternatively within 0.5%.

As used herein, the term “substantially” and its variations are defined as being largely but not necessarily wholly what is specified as understood by one of ordinary skill in the art, and in one non-limiting aspect substantially refers to ranges within 10%, within 5%, within 1%, or within 0.5%.

Various numerical ranges are disclosed herein. Because these ranges are continuous, they include every value between the minimum and maximum values. The endpoints of all ranges reciting the same characteristic or component are independently combinable and inclusive of the recited endpoint. Unless expressly indicated otherwise, the various numerical ranges specified in this application are approximations. The endpoints of all ranges directed to the same component or property are inclusive of the endpoint and independently combinable. The term “from more than 0 to amount” means that the named component is present in some amount more than 0, and up to and including the higher named amount.

As used herein, “combinations thereof” is inclusive of one or more of the recited elements, optionally together with a like element not recited, e.g., inclusive of a combination of one or more of the named components, optionally with one or more other components not specifically named that have essentially the same function. As used herein, the term “combination” is inclusive of blends, mixtures, alloys, reaction products, and the like.

As used herein, the term “energy conversion device” refers to an electrochemical cell that converts the chemical energy of fuels directly into electrical energy. In an embodiment, the energy conversion device may be a metal-air battery or a fuel cell.

As used herein, the term “metal-air battery” refers to an electrochemical cell that uses an anode made of a metal or a metal alloy and a cathode of ambient air (generally referred to as air cathode), with an electrolyte. As used herein, the terms “cathode” and “anode” refer to the electrodes of an energy conversion device such as a metal-air battery. As used herein, the term “electrolyte” refers to a material that allows ions to migrate therethrough, but which does not allow electrons to conduct therethrough. During discharging of the metal-air battery, a reduction reaction occurs at the air cathode while the anode is oxidized. The term “metal-air battery”, as used herein, may refer to a single electrochemical cell (that may be referred to as a metal-air battery cell or a metal-air cell) or a plurality of electrochemical cells connected in series and/or parallel configuration.

As used herein, the term “hydrogen evolution reaction (HER)” may refer to a reaction between a hydrogen ion and an electron at an anode of an energy conversion device e.g., a metal-air battery to produce hydrogen. This is a parasitic reaction that reduces the performance of the metal-air battery.

As used herein, the term “energy density” can be defined as the amount of energy that can be generated for a given unit weight of an energy conversion device such as a metal-air battery. It is expressed as Watt hours per kilogram (Wh/kg).

As used herein, the term “specific capacity” corresponds to an amount of electric charge (milliampere hours (mAh)) delivered by one gram of an electrode material of an electrode. It is used to describe the performance of the electrode and is expressed as mAh per gram (mAh/g).

As used herein, the term “Coulombic efficiency” is defined as a ratio of a discharge capacity of an electrode material to a theoretical discharge capacity derived from the electrochemical calculations involving Faraday's law. It describes an effective battery capacity realized while generating power and is usually expressed as a fraction, less than 1.

As used herein, the term “electrolyte life” is defined as an amount of electric charge derived per volume of the electrolyte. It is expressed as ampere hours per millilitre (Ah/ml).

As used herein, the term “discharge cycle” refers to a process of discharging a metal-air battery until it is completely discharged. The completely discharged metal-air battery may usually mean that the metal-air battery is discharged to 80 percent depth-of-discharge or more.

As used herein, the term “electrolyte additive” refers to a chemical compound which when added to an electrolyte minimizes hydrogen evolution reaction (HER) at an anode of an energy conversion device e.g., a metal-air battery, and may also improve a discharge potential by activating the surface of the anode for the electrochemical reaction. The electrolyte additive, hereinafter, is also otherwise termed as “corrosion inhibitor”, “inhibitor” or “additive”.

An embodiment of the present disclosure may be an energy conversion device. The energy conversion device includes a cathode, an anode; and an alkaline electrolyte disposed between the cathode and the anode. The anode includes an aluminium-magnesium alloy. The alkaline electrolyte includes an electrolyte additive. The electrolyte additive includes zinc oxide, L-cysteine, or a combination thereof.

In an embodiment of the present disclosure, the energy conversion device may be a battery. In a specific embodiment, the energy conversion device may be a metal-air battery. In an embodiment, the energy conversion device may be a flow-type battery where the electrolyte is constantly circulated. In a flow-type battery, the electrolyte is contained in a reservoir, and is pumped to the battery, and the used electrolyte is sent back to the reservoir.

In an embodiment of the present disclosure, the energy conversion device may include a battery having a single electrochemical cell. In another embodiment of the present disclosure, present disclosure, the energy conversion device may include a battery having a plurality of electrochemical cells in a series configuration, a parallel configuration or a combination of a series and parallel configuration.

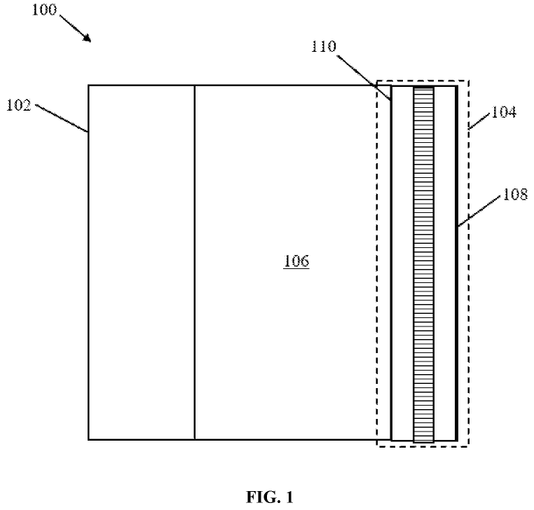

Referring now to FIG. 1, a schematic diagram of an energy conversion device 100, in accordance with an embodiment of the present disclosure, is shown. The energy conversion device 100 includes an anode 102, a cathode 104, and an electrolyte 106 disposed between the anode 102 and the cathode 104.

In an embodiment, the energy conversion device 100 may be a metal-air battery. In the metal-air battery 100, the anode 102 includes a metal or a metal alloy as an anodic material and may be referred to as a metal anode, the cathode uses air or oxygen as a cathodic material and may be referred to as an air cathode. During the operation of the metal-air battery 100, the anode 102 gets oxidized, releasing electrons that reach the cathode 104 via an external circuit. At the cathode 104, oxygen gets reduced by the electrons in the presence of water molecules from the electrolyte 106. The electrolyte 106 supports the transport of the hydroxyl ions (OH⁻) between the anode 102 and the cathode 104. The ionic conductivity and ionic concentration of the electrolyte 106 affect the specific capacity, power performance and energy density of the metal-air battery 100. Increasing the temperature and molarity of the electrolyte 106 can enhance the ionic conductivity and therefore the performance of the battery 100.

In an embodiment of the present disclosure, the anode 102 includes an aluminium alloy. The use of the aluminium alloy is beneficial as compared to pure aluminium for the anode 102 as the aluminium alloy improves the activation of a surface of the anode 102 for the electrochemical reaction in the metal-air battery 100. In an embodiment of the present disclosure, the anode 102 may include an aluminium-magnesium alloy. In an embodiment of the present disclosure, the aluminium-magnesium alloy may include magnesium in an amount ranging from about 0.1 percent to about 10 percent. In an embodiment, the aluminium-magnesium alloy may comprise magnesium in a range from about 1 percent to about 5 percent of magnesium. In an embodiment, the aluminium-magnesium alloy may comprise magnesium in a range from about 2.2 percent to about 2.8 percent. The aluminium-magnesium alloy may also include trace amounts of metals or metalloids.

As discussed, the cathode 104 may be an air cathode. At the cathode 104, oxygen reacts at the cathode with water from the electrolyte to form hydroxide ions, often in the presence of a catalyst. In an embodiment, the cathode 104 may include a catalyst. In an embodiment, the catalyst of the cathode 104 may include a precious metal, such as platinum (Pt), palladium (Pd), gold (Au), silver (Ag) or any alloys thereof. In another embodiment of the present disclosure, the catalyst may include transition metal oxides/chalcogenides, metal macrocyclic compounds, carbonaceous materials, or combinations thereof. In yet another embodiment of the present disclosure, the transition metal may include cobalt (Co), copper (Cu), nickel (Ni), iron (Fe) or manganese (Mn).

In addition to the catalyst, the cathode 104 may include a conductive carbon and a binder. Examples of conductive carbon include graphene, graphite, or a combination thereof. The binder may be a polymer-based binder. In an embodiment, the binder of the cathode 104 may be a fluoropolymer-based binder. Examples of the binders include, but are not limited to, polyvinylidene fluoride (PVDF), polytetrafluoroethylene (PTFE), perfluoroalkoxy (PFA), polyethylene, or any combinations thereof. In an embodiment, the cathode 104 has a porous structure. The oxygen from the atmosphere enters the cathode 104 through an external surface 108 and travels via the porous structure to an internal surface 110 of the cathode 104.

The internal surface 110 of the cathode 104 is in direct contact with the electrolyte 106.

In an embodiment, the alkaline electrolyte 106 may include a hydroxide. Examples of alkaline electrolytes include sodium hydroxide (NaOH), potassium hydroxide (KOH) or a combination thereof. In an embodiment, the alkaline electrolyte may include an aqueous solution of sodium hydroxide, potassium hydroxide or a combination thereof.

In an embodiment, the alkaline electrolyte 106 may be an aqueous solution of sodium hydroxide with a concentration in a range from about 2 moles per litre to about 10 moles per litre. In an embodiment of the present disclosure, the alkaline electrolyte may be an aqueous solution of sodium hydroxide with a concentration in a range from about 3.5 moles per litre to about 8.5 moles per litre. In an embodiment of the present disclosure, the alkaline electrolyte may be an aqueous solution of sodium hydroxide with a concentration in a range from about 4 moles per litre to about 6 moles per litre.

In an embodiment of the present disclosure, the alkaline electrolyte 106 may be an aqueous solution of potassium hydroxide with a concentration in a range from about 2 moles per litre to about 10 moles per litre. In an embodiment of the present disclosure, the alkaline electrolyte may be an aqueous solution of potassium hydroxide with a concentration in a range from about 3.5 moles per litre to about 8.5 moles per litre. In an embodiment of the present disclosure, the alkaline electrolyte may be an aqueous solution of potassium hydroxide with a concentration in a range from about 4 moles per litre to about 6 moles per litre.

In an embodiment, the alkaline electrolyte 106 may further include other organic electrolytes such as ethanol, ionic liquids, hydrogels, or combinations thereof.

According to an embodiment of the present disclosure, the alkaline electrolyte 106 includes an electrolyte additive. In an embodiment, the electrolyte additive includes zinc oxide, L-cysteine, or a combination thereof. In an embodiment, the electrolyte additive includes a combination of zinc oxide and L-cysteine. Other examples of electrolyte additives may be ethylene diamine tetraacetic acid (EDTA), urea, and calcium oxide.

In an embodiment, a concentration of the electrolyte additive may be in a range from about 0.005 moles per litre to about 0.5 moles per litre in the electrolyte 106. In a specific embodiment, a concentration of the electrolyte additive may be in a range from about 0.001 moles per litre to about 0.1 moles per litre. For example, a concentration of zinc oxide may range from about 0.001 moles per litre to about 0.1 moles per litre in the electrolyte. In another example, a concentration of L-cysteine may range from about 0.01 moles per litre to 0.1 moles per litre.

In an embodiment of the present disclosure, the electrolyte additive may include zinc oxide in a concentration range from about 0.005 moles per litre to about 0.5 moles per litre and L-cysteine in a concentration range from about 0.005 moles per litre to about 0.5 moles per litre in the electrolyte. In an embodiment, the electrolyte additive may include zinc oxide in a concentration range from about 0.001 moles per litre to about 0.1 moles per litre and L-cysteine in a concentration range from about 0.001 moles per litre to about 0.1 moles per litre in the electrolyte. In another embodiment of the present disclosure, the electrolyte additive may comprise zinc oxide in a concentration range from about 0.01 moles per litre to about 0.05 moles per litre and L-cysteine in a concentration from about 0.01 moles per litre to about 0.05 moles per litre in the electrolyte.

Such electrolyte additives may form a protective layer on a surface of an anode to inhibit or reduce hydrogen evolution reaction (HER). When an anode of a metal-air battery is made of pure aluminium, the electrolyte additives may form a protective layer on the surface of the pure aluminium anode, which may reduce the activation of the anode for the electrochemical reaction and thus cause a low discharge voltage. In contrast, when an anode is made of aluminium-magnesium alloy as described in an embodiment of the present disclosure, the electrolyte additive may form a discontinuous protective layer on the surface of the anode due to the presence of more than one metal (e.g., Al and Mg) in the anode. This discontinuous protective layer on the anode surface may improve the activation of the anode by providing a larger activation surface as compared to that of the pure aluminium anode, which results in a higher discharge voltage than the discharge voltage when the metal-air battery has the pure aluminium anode.

In an embodiment of the present disclosure, the energy conversion device may operate for at least 1000 hours. In another embodiment of the present disclosure, the energy conversion device may operate for more than 1200 hours.

In an embodiment of the present disclosure, the energy conversion device may have an energy density in a range from about 2000 watt-hours per kilogram to about 4000 watt-hours per kilogram.

In an embodiment of the present disclosure, the energy conversion device may have a Coulombic efficiency in a range from about 70 percent to about 99 percent.

### Examples

Example 1: Multiple metal-air batteries were constructed according to the embodiments of the present disclosure. Each metal-air battery had an air cathode, a metal anode and 4.5M potassium hydroxide (KOH) as an electrolyte. The metal anode was made of a commercially available Al—Mg alloy. The dimensions of the metal anode were 3.7 cm×3.7 cm×3 mm. A ratio of the active surfaces of the air cathode and the metal anode is 1. The metal-air batteries were formed using different additives and their different concentrations in the electrolyte. Table 1 shows different additives, and their concentrations present in the electrolyte of the respective metal-air batteries.

The performance of each metal-air battery was measured at 45° C. while the metal-air battery was discharged at a constant current density of 150 mA/cm². The measured performance parameters (initial discharge voltage, energy density, specific capacity, coulombic efficiency and electrolyte life) are displayed in Table 1.

TABLE 1
Table 1

| | Conc. Of | Conc. of | Initial | | | | |
|---|---|---|---|---|---|---|---|
| | ZnO | L-cysteine | discharge | Energy | Specific | Coulombic | Electrolyte |
| Sl. | (moles per | (moles per | voltage | density | capacity | efficiency | life |
| No. | litre) | litre) | (V) | (Wh/kg) | (mAh/g) | (%) | (Ah/ml) |
| 1 | 0.006 | 0 | 1.000 | 2169.69 | 2294.90 | 77 | |
| 2 | 0.012 | 0 | 1.008 | 2355.08 | 2480.58 | 83 | 0.113 |
| 3 | 0.021 | 0 | 0.987 | 2411.06 | 2658.10 | 89 | |
| 4 | 0.030 | 0 | 0.956 | 2311.32 | 2572.89 | 86 | |
| 5 | 0 | 0.020 | 1.038 | 2473.39 | 2550.02 | 86 | 0.116 |
| 6 | 0 | 0.030 | 1.010 | 2475.65 | 2613.60 | 88 | 0.118 |
| 7 | 0.012 | 0.020 | 0.939 | 2483.39 | 2792.21 | 94 | |
| 8 | 0.021 | 0.020 | 0.911 | 2417.19 | 2798.26 | 94 | |
| 9 | 0.012 | 0.030 | 0.961 | 2411.42 | 2804.26 | 94 | |
| 10 | 0.021 | 0.030 | 0.975 | 2585.74 | 2833.90 | 95 | 0.119 |

It can be observed from Table 1 that the addition of an electrolyte additive, such as zinc oxide (ZnO), L-cysteine, or combinations thereof, results in improving the battery performance. For example, an improvement can be seen in the energy density, specific capacity, Coulombic efficiency, and/or electrolyte life when an amount of ZnO increased from 0.006 moles per litre to 0.021 moles per litre, when an amount of L-cysteine increased from 0.020 moles per litre to 0.030 moles per litre and when a combination of ZnO and L-cysteine was used. It can be easily observed that the composition of 0.030 moles per litre of L-cysteine and 0.021 moles per litre of ZnO showed improved performance as compared to only ZnO as electrolyte additive, or only L-cysteine as electrolyte additive, respectively.

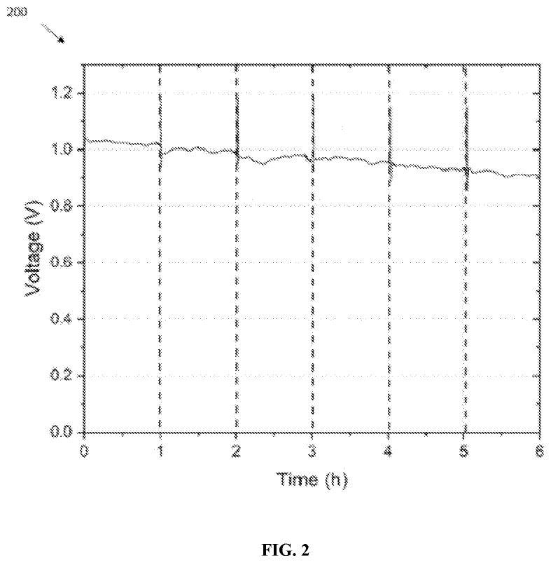

FIG. 2 is a plot 200 of voltage (V) versus time (T) in hours for multiple discharge cycles of the metal-air battery that had 0.030 moles per litre of L-cysteine and 0.021 moles per litre, as described above in example 1. Each discharge cycle was for 1 hour and a time interval between two successive discharge cycles was about 24 hours. After completing each discharge cycle, the used electrolyte was replaced with a fresh electrolyte (4.5M KOH including 0.030 moles per litre of L-cysteine and 0.021 moles per litre of ZnO) of the same composition and including the same additives. It was observed that after every discharge cycle, there was a very little decrement in the discharge voltage of the metal-air battery. Further, at the beginning of each discharge cycle, the discharge voltage was lower than the discharge voltage at the end of the previous discharge cycle, but it was recovered within a few minutes during the respective discharge cycle. This indicates that the fresh electrolyte for the successive discharge cycle had dissolved the passivation layer formed on the anode during the previous discharge cycle and hence improved the activation of the anode surface. Though a marginal decrement in the discharge voltage was observed during the first few cycles, the overall decrement in discharge voltage with every discharge cycle was well within the workable specification. The plot 200 confirmed the superior performance of the combination of additives in enhancing the ability of the Al—Mg alloy anode to operate at a similar discharge voltage after every discharge cycle.

### Advantages

The technical advantages brought in by the present disclosure are as follows;
1. The hydrogen evolution reaction at an anode made of aluminium-magnesium alloy of a metal-air battery is observed to be suppressed with the use of an electrolyte additive comprising zinc oxide, L-cysteine or zinc oxide and L-cysteine.
2. The performance of a metal-air battery with an electrolyte additive comprising zinc oxide and L-cysteine, is better than another metal-air battery with no additive, or with only zinc oxide or only L-cysteine as an electrolyte additive.

While considerable emphasis has been placed herein on the components and component parts of the various embodiments, it will be appreciated that many embodiments can be made and that many changes can be made in the embodiments without departing from the scope and spirit of the invention. These and other changes in the various embodiment of the disclosure will be apparent to those skilled in the art from the disclosure herein, whereby it is to be distinctly understood that the foregoing descriptive matter is to be interpreted merely as illustrative of the disclosure and not as a limitation.

What is claimed is:

1. An energy conversion device, comprising:
a cathode;
an anode comprising an aluminium-magnesium alloy; and
an alkaline electrolyte disposed between the cathode and the anode, wherein the alkaline electrolyte comprises an electrolyte additive comprising zinc oxide, L-cysteine, or a combination thereof.

2. The energy conversion device as claimed in claim 1, wherein the energy conversion device is a metal-air battery.

3. The energy conversion device as claimed in claim 1, wherein an amount of magnesium in the aluminium-magnesium alloy is in a range from about 0.1 percent to about 10 percent.

4. The energy conversion device as claimed in claim 1, wherein the alkaline electrolyte comprises potassium hydroxide.

5. The energy conversion device as claimed in claim 1, wherein a concentration of the electrolyte additive is in a range from about 0.005 moles per litre to about 0.5 moles per litre in the alkaline electrolyte.

6. The energy conversion device as claimed in claim 1, wherein the electrolyte additive comprises zinc oxide and L-cysteine.

7. The energy conversion device as claimed in claim 6, wherein a concentration of zinc oxide is in a range from about 0.001 moles per litre to about 0.1 moles per litre, and a concentration of L-cysteine is in a range from about 0.001 moles per litre to about 0.1 moles per litre in the alkaline electrolyte.

8. The energy conversion device as claimed in claim 1, wherein the cathode comprises a catalyst and a conductive carbon.

9. A metal-air battery, comprising:
a cathode;
an anode comprising an aluminium-magnesium alloy; and
an alkaline electrolyte disposed between the cathode and the anode, wherein the alkaline electrolyte comprises potassium hydroxide and an electrolyte additive,
wherein the electrolyte additive comprises zinc oxide and L-cysteine.

10. The metal-air battery as claimed in claim 9, wherein a concentration of zinc oxide is in a range from about 0.005 moles per litre to about 0.05 moles per litre and a concentration of L-cysteine is in a range from about 0.01 moles per litre to about 0.05 moles per litre in the alkaline electrolyte.
